(19) United States
(12) Patent Application Publication
(10) Pub. No.: US 2012/0134054 A1
(43) Pub. Date: May 31, 2012

(54) MAGNETIC RECORDING HEAD, MAGNETIC HEAD ASSEMBLY, AND MAGNETIC RECORDING APPARATUS

(75) Inventors: Akihiko TAKEO, Kunitachi-shi (JP); Mariko KITAZAKI, Kawasaki-shi (JP); Kenichiro YAMADA, Tokyo (JP); Katsuhiko KOUI, Yokohama-shi (JP); Hitoshi IWASAKI, Tokyo (JP)

(73) Assignee: Kabushiki Kaisha Toshiba, Tokyo (JP)

(21) Appl. No.: 13/224,830

(22) Filed: Sep. 2, 2011

(30) Foreign Application Priority Data
Nov. 30, 2010 (JP) 2010-267067

(51) Int. Cl. G11B 5/127; G11B 5/60

(52) U.S. Cl. 360/234.3; 360/110; G9B/5.04; G9B/5.229

(57) ABSTRACT

According to one embodiment, a magnetic recording head includes a main magnetic pole generating a recording magnetic field in a magnetic recording medium, a return yoke paired with the main magnetic pole and a spin torque oscillator interposed between the main magnetic pole and the return yoke and including a first magnetic layer, a second magnetic layer and a third magnetic layer of Fe₄N, the second magnetic layer being interposed between the first magnetic layer and the third magnetic layer, wherein the magnetic recording head is configured to allow a current for oscillation to flow in a direction from the first magnetic layer to the third magnetic layer.

### CROSS-REFERENCE TO RELATED APPLICATIONS

This application is based upon and claims the benefit of priority from Japanese Patent Application No. 2010-267067, filed Nov. 30, 2010; the entire contents of which are incorporated herein by reference.

### FIELD

Embodiments described herein relate generally to a magnetic recording head using a spin torque oscillator, a magnetic head assembly and a magnetic recording apparatus.

### BACKGROUND

As a conventional spin torque oscillator, there is a spin torque oscillator including an oscillation layer and a spin injection layer. In such a spin torque oscillator, it is important to reduce a drive current density for beginning a spin torque oscillation, that is, a critical current density.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of a magnetic recording head and a magnetic recording medium of an embodiment;

FIG. 2 is a view showing a magnetic recording head of a first embodiment;

FIG. 3 is a view showing a magnetic recording head of a second embodiment;

FIG. 4 is a view showing a magnetic recording head of a third embodiment;

FIG. 5 is a view showing a magnetic recording head according to the embodiment;

FIG. 6A and FIG. 6B are views showing a magnetic head assembly of the embodiment; and

FIG. 7 is a view showing a magnetic recording apparatus of the embodiment.

### DETAILED DESCRIPTION

Various embodiments will be described hereinafter with reference to the accompanying drawings.

In general, according to one embodiment, a magnetic recording head comprises a main magnetic pole generating a recording magnetic field in a magnetic recording medium, a return yoke paired with the main magnetic pole and a spin torque oscillator interposed between the main magnetic pole and the return yoke and including a first magnetic layer, a second magnetic layer and a third magnetic layer of Fe₄N, the second magnetic layer being interposed between the first magnetic layer and the third magnetic layer, wherein the magnetic recording head is configured to allow a current for oscillation to flow in a direction from the first magnetic layer to the third magnetic layer.

(Magnetic Recording Head)

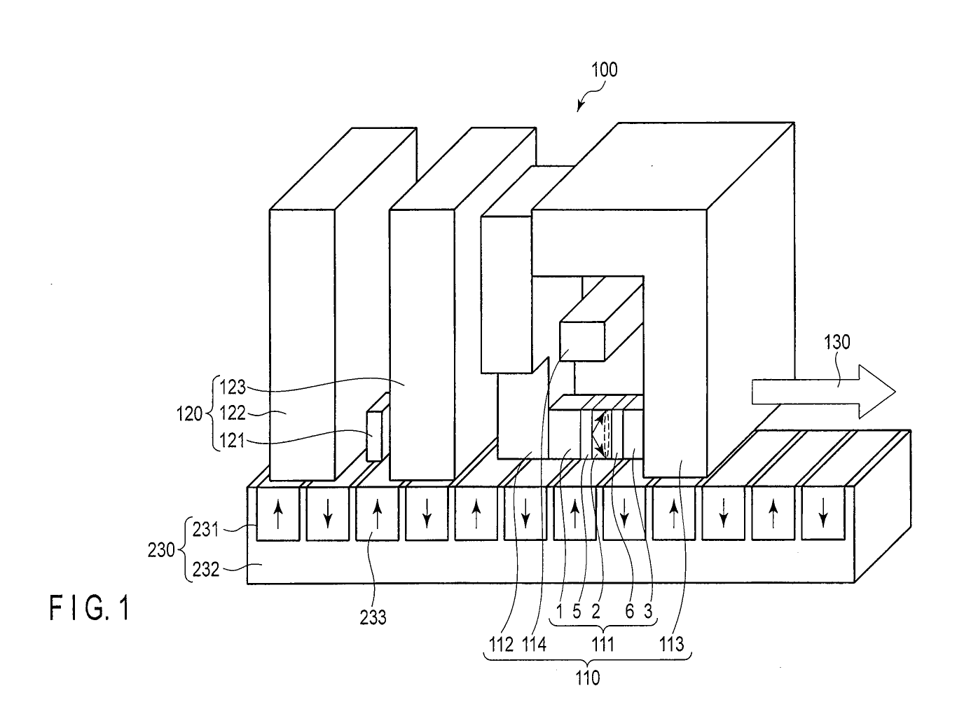

FIG. 1 shows an example of a magnetic recording head and a magnetic recording medium of an embodiment. A magnetic recording head 100 is disposed on a magnetic recording medium 230. The magnetic recording head 100 includes a write head portion 110 and a read head portion 120. Note that the surface of the magnetic recording head 100 opposite to the magnetic recording medium 230 is called an air bearing surface.

The write head portion 110 includes a main magnetic pole 112, a return yoke 113, and a spin torque oscillator 111 interposed therebetween. One of the surfaces of the spin torque oscillator 111 forms a part of the air bearing surface. Further, a coil 114 is wound around a part of a magnetic path passing through the main magnetic pole 112 and the return yoke 113. In the spin torque oscillator 111 shown in FIG. 1, a first magnetic layer 1, a first interlayer 5, a second magnetic layer 2, a second interlayer 6, and a third magnetic layer 3 are stacked from the main magnetic pole 112 side.

In the read head portion 120, a magnetic read element 121 is interposed between magnetic shields 122 and 123.

The magnetic recording medium 230 includes a medium substrate 232 and a magnetic recording layer 231 disposed thereon. A large number of record units 233 are formed in the magnetic recording layer 231 such that the write head portion 110 is able to function.

In the magnetic recording head 100 and the magnetic recording medium 230 shown in FIG. 1, the magnetic recording head 100 moves relative to a specific position of the magnetic recording medium 230 and writes data to be recorded to, and reads recorded data from, the magnetic recording layer 231. The position of the magnetic recording head 100 on the magnetic recording medium 230 is controlled by the rotation of the magnetic recording medium 230 and the parallel movement of the magnetic recording head 100. In the figure, the direction of relative movement of the magnetic recording head 100 over the magnetic recording medium 230 when the magnetic recording medium 230 rotates is shown as an arrow 130.

The write head portion 110 writes data to the magnetic recording layer 231. When a current is supplied to the coil 114 from a power supply for a recording magnetic field generation, a write magnetic field which passes through the main magnetic pole 112, the magnetic recording medium 230, and the return yoke 113 is generated. Magnetization in a direction perpendicular to the magnetic recording layer 231 immediately under the main magnetic pole 112 is generated because of the write magnetic field. Simultaneously with the application of the write magnetic field, the spin torque oscillator 111 applies a high frequency to the magnetic recording layer 231. With the operation, the coercive force of the magnetic recording layer 231 is reduced, and the writing by the main magnetic pole 112 becomes easy.

The read head portion 120 reads the recorded data written to the record units 233. The magnetic read element 121 converts the magnetic field of the record units 233 immediately under the magnetic read element 121 to electrical signals. When, for example, a magnetoresistive effect element is used as the magnetic read element 121, the resistivity of the magnetoresistive effect element is changed by the magnetic field of the record units 233. The change can be read as the recorded data. The magnetic shields 122 and 123 cut off, from the magnetic read element 121, a magnetic field from other than the record units 233 to be read. For example, the magnetic shields 122 and 123 cut off the write magnetic field generated from the write head portion 110.

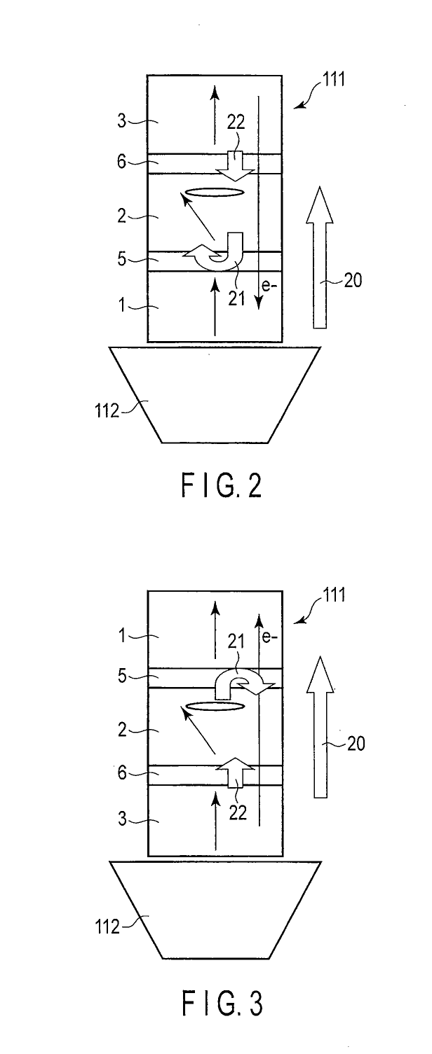

FIG. 2 shows a magnetic recording head of a first embodiment. FIG. 2 shows only a spin torque oscillator 111 and a main magnetic pole 112. In the magnetic recording head of the first embodiment, the spin torque oscillator 111 is formed by stacking a first magnetic layer 1, a first interlayer 5, a second magnetic layer 2, a second interlayer 6, and a third magnetic layer 3 from the main magnetic pole 112 side.

The first magnetic layer 1 is of a metal magnetic material having perpendicular magnetic anisotropy. FIG. 2 schematically shows that the first magnetic layer 1 has the perpendicular magnetic anisotropy by a vertical arrow. Since the first magnetic layer 1 has a role of injecting spin into the second magnetic layer 2, the first magnetic layer 1 may also be called a spin injection layer.

The second magnetic layer 2 is of a metal magnetic material. When spin is injected from the spin injection layer, the second magnetic layer 2 is made to oscillate by the precession movement of the spin being generated. At this time, since a gap magnetic field 20 generated between the main magnetic pole 112 and the return yoke 113 faces a film thickness direction, the rotational axis of the precession movement of the spin also faces the film thickness direction. FIG. 2 schematically illustrates how the precession movement is performed. Since the second magnetic layer 2 is made to oscillate, the second magnetic layer 2 may be called an oscillation layer.

The third magnetic layer 3 is of Fe₄N. FIG. 2 schematically illustrates how the magnetization of the third magnetic layer 3 faces the film thickness direction. The third magnetic layer 3 injects spin into the second magnetic layer 2. Therefore, the third magnetic layer 3 may also be called a spin injection layer like the first magnetic layer 1. The conventional spin torque oscillator is not provided with the third magnetic layer 3. In contrast, in the spin torque oscillator 111 according to the embodiment, since the spin is injected making use of not only the first magnetic layer 1 but also the third magnetic layer 3, the efficiency of the spin injection can be increased and a critical current density for oscillation can be reduced. That is, the spin torque oscillator 111 can be made to oscillate by a lower current density.

In the first embodiment, a current for making the spin torque oscillator 111 oscillate flows from the first magnetic layer 1 to the third magnetic layer 3. That is, electrons migrate from the third magnetic layer 3 to the first magnetic layer 1 as illustrated in the figure. As the electrons migrate, spin is injected into the second magnetic layer 2.

The spin injection from the third magnetic layer 3 into the second magnetic layer 2 is caused as a transmission 22 of spin torque. That is, downspin migrates from the third magnetic layer 3 to the second magnetic layer 2. This is because the 3d electrons of downspin of Fe₄N dominantly contribute to the conduction.

In contrast, the spin injection from the first magnetic layer 1 into the second magnetic layer 2 is caused as a reflection 21 of the spin torque. That is, upspin mainly moves from the second magnetic layer 2 to the first magnetic layer 1, whereas since it is difficult for the downspin to move as described above, the downspin stays in the second magnetic layer 2. This is because the upspin electrons of the first magnetic layer 1 dominantly contribute to the conduction.

FIG. 3 shows a magnetic recording head of a second embodiment. FIG. 3 shows only a spin torque oscillator 111 and a main magnetic pole 112. In the second embodiment, the respective layers which constitute the spin torque oscillator 111 are sequentially stacked in the order opposite to that of the first embodiment. That is, a third magnetic layer 3, a second interlayer 6, a second magnetic layer 2, a first interlayer 5, and a first magnetic layer 1 are sequentially stacked from the main magnetic pole 112 side. Although the direction of a gap magnetic field 20 is the same as the first embodiment, since the order of the first magnetic layer 1 and the third magnetic layer 3 is inverted, the direction in which a current flows is inverted. In other words, also in the second embodiment, the current flows from the first magnetic layer 1 to the third magnetic layer 3.

In the second embodiment, since spin is injected making use of not only the first magnetic layer 1 but also the third magnetic layer 3 like the first embodiment, there can be obtained an effect that the critical current density for oscillation can be reduced. That is, spin is injected from the first magnetic layer 1 into the second magnetic layer 2 by the reflection 21 of spin torque, and spin is injected from the third magnetic layer 3 into the second magnetic layer 2 by the transmission 22 of the spin torque.

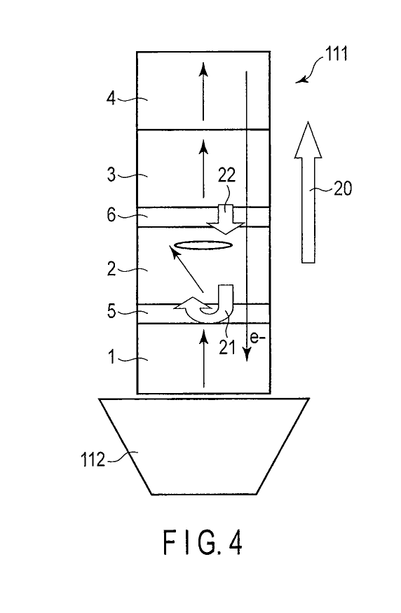

FIG. 4 shows a magnetic recording head of a third embodiment. FIG. 4 shows only a spin torque oscillator 111 and a main magnetic pole 112. In the spin torque oscillator 111 in the third embodiment, a fourth magnetic layer 4 is further added to the spin torque oscillator 111 in the first embodiment. That is, a first magnetic layer 1, a first interlayer 5, a second magnetic layer 2, a second interlayer 6, a third magnetic layer 3, and a fourth magnetic layer 4 are stacked from the main magnetic pole 112 side. The fourth magnetic layer 4 is of a magnetic material having an easy axis of magnetization in a film thickness direction.

In the third embodiment, since spin is injected making use of not only the first magnetic layer 1 but also the third magnetic layer 3 like the first embodiment, there can be obtained an effect that the critical current density for oscillation can be reduced. Further, the fourth magnetic layer 4 stabilizes the magnetization of the third magnetic layer 3 in the film thickness direction. That is, the third magnetic layer 3 can be saturated by the magnetic field in the film thickness direction by the exchange coupling force between the fourth magnetic layer 4 and the third magnetic layer 3. When spin is injected from the third magnetic layer 3, although the magnetization of the third magnetic layer 3 in the film thickness direction is fluctuated by the reaction of the spin injection, the magnetic field in the film thickness direction by the fourth magnetic layer 4 can minimize the influence of the fluctuation. As a result, the efficiency of spin injection from the third magnetic layer 3 into the second magnetic layer 2 is increased and the critical current density for oscillation is further reduced.

Examples of the respective layers which can be used in the magnetic recording heads according to the embodiments will be explained.

As the material of the second magnetic layer 2 (oscillation layer), a magnetic material having small magnetic anisotropy energy can be used. Specifically, materials such as CoFe, CoNiFe, NiFe, CoZrNb, FeN, FeSi, FeAlSi, FeCoAl, FeCoSi, FeCoB, FeCoGa, FeCoGe, FeCoMn, and FeCoCr can be used. The thickness of the second magnetic layer 2 is preferably from 5 to 30 nm, and is preferably, for example, 13 nm. The saturation magnetic flux density of the second magnetic layer 2 is preferably from 0.5 to 2.3 T.

As the material of the first magnetic layer 1 (spin injection layer), CoCr alloys such as CoCrPt, CoCrTa, CoCrTaPt, and CoCrTaNb, RE-TM amorphous alloys such as TbFeCo, artificial lattices such as Co/Pd, Co/Pt, CoCrTa/Pd, Co/Ni, CoFe/Ni, and FeCo/Ni, CoPt alloys, FePt alloys, and SmCo alloys can be used. Alternatively, a stacked structure of these materials and a material having relatively small magnetic anisotropy energy, such as an FeCo alloy or a Co-based Heusler alloy, can be used. For example, a stacked structure in which Co and Ni are stacked can be used. The thickness of the first magnetic layer 1 is preferably from 3 to 30 nm.

Fe₄N is used as the material of the third magnetic layer 3 (spin injection layer). The thickness of the third magnetic layer 3 is preferably set so that a magnetic volume KuV becomes larger than that of a material of the second magnetic layer 2. The thickness can be set to, for example, from 5 to 30 nm. With the setting as described above, since the third magnetic layer 3 is hardly disturbed by the spin torque reflected from the second magnetic layer 2, spin is effectively injected into the second magnetic layer 2.

As the material of the fourth magnetic layer 4 (bias layer), a magnetic material having an easy axis of magnetization in the film thickness direction can be used. Further, a material having a magnetic anisotropy energy Ku in the range of 1 to 10 Merg/cc is preferably used. For example, CoCr alloys such as CoCrPt, CoCrTa, CoCrTaPt, and CoCrTaNb, RE-TM amorphous alloys such as TbFeCo, artificial lattices such as Co/Pd, Co/Pt, CoCrTa/Pd, Co/Ni, CoFe/Ni, and FeCo/Ni, a CoPt alloy, an FePt alloy, an SmCo alloy, and the like can be used. The thickness of the fourth magnetic layer 4 can be set to 3 to 30 nm.

A non-magnetic material having a high spin transmittance is preferably used as the material of the first interlayer 5 and the second interlayer 6. For example, Cu, Ag, Al, and the like can be used. The thickness of the first interlayer 5 and the second interlayer 6 is preferably set so as to adequately control the magnetic coupling between the oscillation layer and the spin injection layer and be made as thin as possible. The thickness can be in the range of, for example, 0.2 to 10 nm and preferably in the range of 1 to 3 nm.

The magnetic recording head or the spin torque oscillator according to the embodiments can be appropriately disposed with other layers in addition to the layers explained above. For example, an underlayer 7 can be interposed between the main magnetic pole 112 and the spin torque oscillator 111. Further, a cap layer 10 can be interposed between the return yoke 113 and the spin torque oscillator 111. As the material of the underlayer 7 and the cap layer 10, Ti, Cu, Ru, Ta, Zr, Nb, Hf, Pt, Pd, and the like can be used. In particular, to increase the degree of order of Fe₄N in the third magnetic layer 3, a (001) surface-oriented material consisting of Ta/Cr/Fe, TaNi/Cr/Fe, TaNi/Cr/Pt, NiNb/Cr/Fe, NiZr/Cr/Fe, and the like and having a metal stacked structure can be used as the material of the underlayer 7. Further, the surface of Ta, TaNi, NiNb, or NiZr is preferably exposed to oxygen to the extent that (001) surface orientation of Cr can be realized.

As the material of the main magnetic pole 112 and the return yoke 113, a magnetic metal can be used. For example, a metal alloy selected from the group consisting of Fe, Co, and Ni can be used. The main magnetic pole 112 and the return yoke 113 may have a function as an electrode for passing a current to the spin torque oscillator 111 in addition to the function as the magnetic pole for generating the write magnetic field. Further, the return yoke 113 may have a function as a trailing shield.

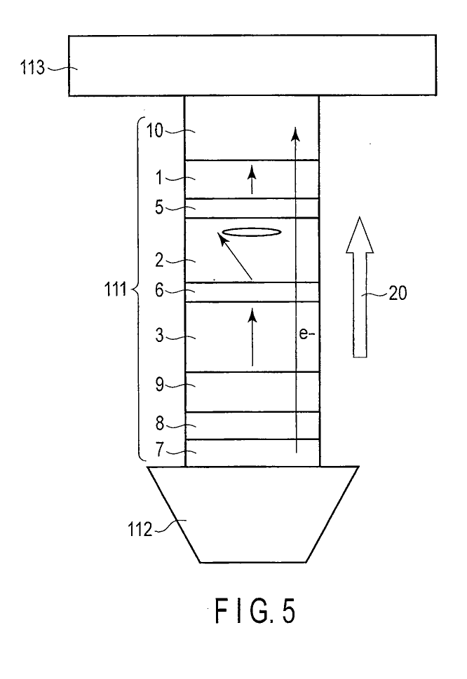

As an example, a magnetic recording head according to the embodiments was manufactured. FIG. 5 shows a configuration of the magnetic recording head. In the magnetic recording head, a spin torque oscillator 111 was interposed between a main magnetic pole 112 and a return yoke 113. Further, the spin torque oscillator 111 was sequentially stacked with an underlayer 7, a buffer layer 8, an Fe layer 9, a third magnetic layer 3, a second interlayer 6, a second magnetic layer 2, a first interlayer 5, a first magnetic layer 1, and a cap layer 10 from the main magnetic pole 112 side.

Specifically, a TaNi layer having a thickness of 4 nm as the underlayer 7, a Cr layer having a thickness of 4 nm as the buffer layer 8, a Fe layer having a thickness of 5 nm as the Fe layer 9, a Fe₄N layer having a thickness of 20 nm as the third magnetic layer 3, a Cu layer having a thickness of 2 nm as the second interlayer 6, a (Fe₅₀Co₅₀)₈₀Al₂₀ layer having a thickness of 13 nm as the second magnetic layer 2, a Cu layer having a thickness of 2 nm as the first interlayer 5, a stacked structure as the first magnetic layer 1, which was formed by alternately stacking a Co layer having a thickness of 0.2 nm and a Ni layer having a thickness of 0.6 nm ten times, and a Ru layer having a thickness of 15 nm as the cap layer 10 were stacked on a main magnetic pole 112 sequentially, and then the return yoke 113 was formed on the stacked layers.

Further, a conventional magnetic recording head was manufactured as an comparative example. That is, a Ta layer having a thickness of 4 nm, a Ru layer having a thickness of 2 nm, a Cu layer having a thickness of 2 nm, a stacked structure as a spin injection layer, which was formed by alternately stacking a Co layer having a thickness of 0.2 nm and a Ni layer having a thickness of 0.6 nm 15 times, a Cu layer having a thickness of 2 nm, a (Fe₅₀Co₅₀)₈₀Al₂₀ layer having a thickness of 13 nm as an oscillation layer and a Ru layer having a thickness of 15 nm were stacked on a main magnetic pole sequentially, and then a return yoke was formed on the stacked layers.

As to the manufactured magnetic recording heads of example and comparative example, critical current densities when an oscillation layer was made to oscillate were measured. As a result, it was found that the critical current density of the magnetic recording head according to the example was more reduced than that of the comparative example.

(Magnetic Head Assembly)

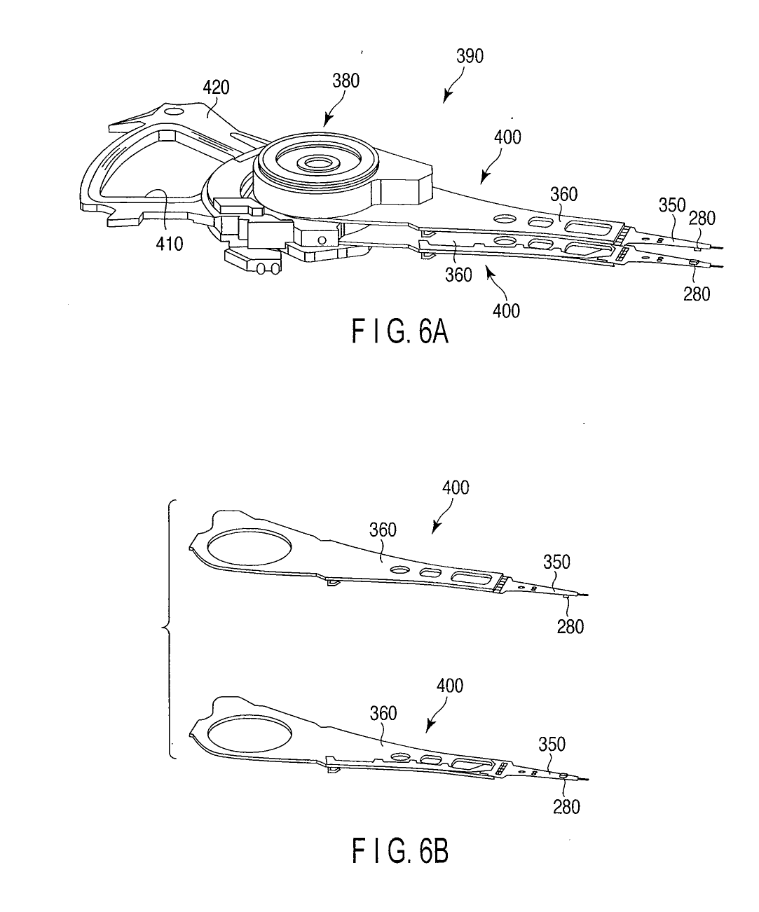

FIG. 6A shows a head stack assembly 390 as a portion of the magnetic recording apparatus according to the present embodiment. FIG. 6B is a perspective view showing a magnetic head assembly (head gimbal assembly [HGA]) 400 as a portion of the head stack assembly 390.

As shown in FIG. 6A, the head stack assembly 390 includes the pivot 380, a head gimbal assembly 400 extending from the pivot 380, and a support frame 420 which extends from the pivot 380 in a direction opposite to the head gimbal assembly 400 and supports a coil 410 of the voice coil motor.

As shown in FIG. 6B, the head gimbal assembly 400 includes the actuator arm 360 extending from the pivot 380, and the suspension 350 extending from the actuator arm 360.

The magnetic head assembly (head gimbal assembly [HGA]) 400 according to the present embodiment includes the magnetic recording head 100, the head slider 280 including the magnetic recording head 100, the suspension 350 equipped with the head slider 280 at one end thereof, and the actuator arm 360 connected to the other end of the suspension 350.

The suspension 350 includes leads (not shown) for reading and writing signals, for heater for controlling the floating height, and for STO111. The leads are electrically connected to the electrodes of the magnetic recording head 100 included in the head slider 280. Electrode pads (not shown) are provided in the head gimbal assembly 400. In the present embodiment, eight electrode pads are provided; two electrode pads for the coil of a main magnetic pole 112, two electrode pads for a magnetic reproducing element 121, two electrode pads for dynamic flying height (DFH), and two electrode pads for STO111.

The tip of the suspension 350 is equipped with the head slider 280 including the magnetic recording head 100.

The head slider 280 is made of, for example, Al₂O₃/TiC, and configured to relatively move above the magnetic recording medium 230 such as a magnetic disk while floating thereover or in contact therewith. The head slider 280 is attached to the tip of a thin film-shaped suspension 350.

When the magnetic recording medium 230 is rotated, the pressing pressure applied by the suspension 350 matches with the pressure developed on the air bearing surface of the head slider 280. The air bearing surface of the head slider 280 is kept away from the surface of the magnetic recording medium 230 at a predetermined floating height. The head slider 280 may be of “in-contact type” which contacts with the magnetic recording medium 230.

(Magnetic Recording Apparatus)

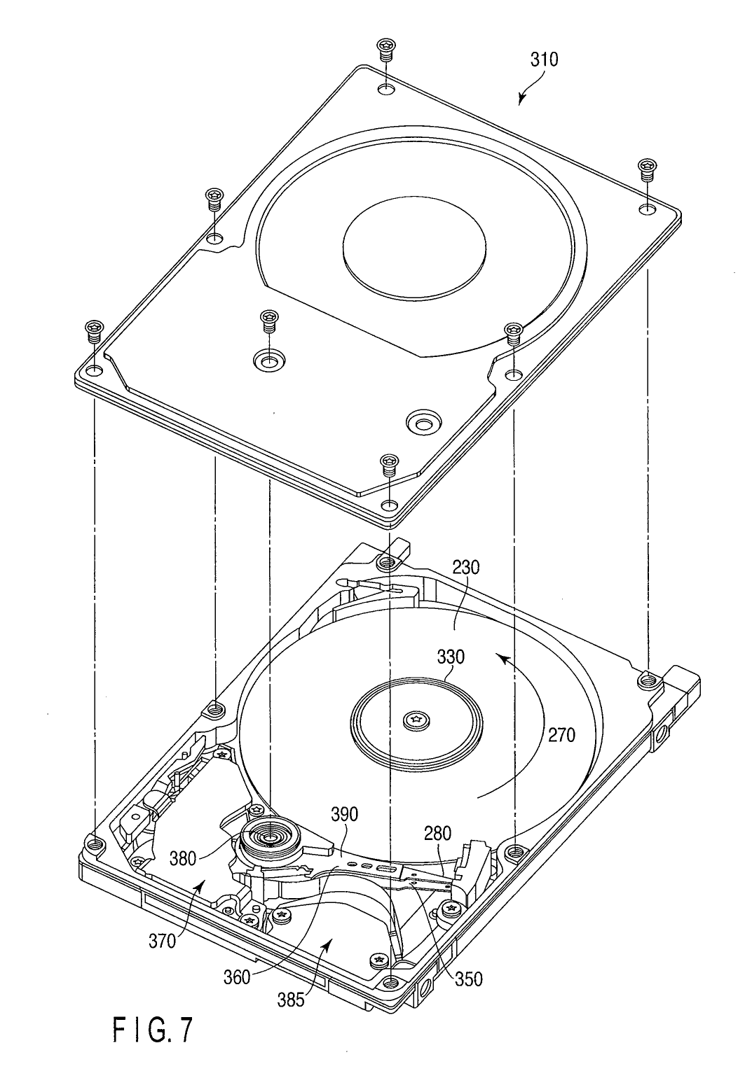

FIG. 7 is a perspective view of a magnetic recording apparatus in which the magnetic recording medium manufactured according to the embodiment is installed.

The magnetic recording apparatus 310 according to the present embodiment includes the magnetic recording medium 230, the magnetic recording head 100, a moving unit which can move the opposing magnetic recording medium 230 and magnetic recording head 100 in a relative manner while keeping them away or in contact with each other, a position controller which places the magnetic recording head 100 to a predetermined recording position on the magnetic recording medium 230, and the signal processor 385 which reads and writes signals on the magnetic recording medium 230 using the magnetic recording head 100. The moving unit may include the head slider 280. The position controller may include the head gimbal assembly 400.

As shown in FIG. 7, the magnetic recording apparatus 310 according to the embodiment is of a type using a rotary actuator. The magnetic recording medium 230 is attached to the spindle motor 330, and is rotated in the direction of arrow A by a motor (not shown) that responds to control signals from a drive controller (not shown). The magnetic recording apparatus 310 may comprise a plurality of magnetic recording medium 230.

The suspension 350 is connected to one end of an actuator arm 360. A voice coil motor 370, a kind of linear motor, is provided on the other end of the actuator arm 360. The voice coil motor 370 is formed of a magnetic circuit including a driving coil (not shown) wound around a bobbin and a permanent magnet and a counter yoke arranged opposite to each other so as to sandwich the coil therebetween.

The actuator arm 360 is held by ball bearings (not shown) provided at two vertical positions of the pivot 380. The actuator arm 360 can be rotatably slid by the voice coil motor 370. As a result, the magnetic head 100 can be accessed any position on the magnetic recording medium 230.

A signal processor 385 (not shown) is provided on the back of the magnetic recording apparatus 310 shown in FIG. 7. The signal processor 385 reads and writes signals to the magnetic recording medium 230 using the magnetic recording head 100. The input and output lines of the signal processor 385 are connected to the electrode pads of the head gimbal assembly 400, and electrically coupled with the magnetic recording head 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording head comprising:
a main magnetic pole generating a recording magnetic field in a magnetic recording medium;
a return yoke paired with the main magnetic pole; and
a spin torque oscillator interposed between the main magnetic pole and the return yoke and including a first magnetic layer, a second magnetic layer and a third magnetic layer of Fe₄N, the second magnetic layer being interposed between the first magnetic layer and the third magnetic layer,
wherein the magnetic recording head is configured to allow a current for oscillation to flow in a direction from the first magnetic layer to the third magnetic layer.

2. The magnetic recording head of claim 1, wherein the spin torque oscillator further includes an interlayer interposed between the first magnetic layer and the second magnetic layer and made of a non-magnetic material.

3. The magnetic recording head of claim 1, wherein the spin torque oscillator further includes an interlayer interposed between the second magnetic layer and the third magnetic layer and made of a non-magnetic material.

4. The magnetic recording head of claim 1, wherein the spin torque oscillator further includes a fourth magnetic layer interposed between the third magnetic layer and the main magnetic pole or the return yoke and having an easy axis of magnetization in a film thickness direction.

5. A magnetic head assembly comprising:
a head slider including the magnetic recording head of claim 1;
a suspension equipped with the head slider at one end thereof; and
an actuator arm connected to the other end of the suspension.

6. A magnetic recording apparatus comprising:
a magnetic recording medium;
the magnetic head assembly of claim 5; and
a signal processor configured to read and write signals on the magnetic recording medium using the magnetic recording head mounted on the magnetic head assembly.
